(19) United States
(12) Patent Application Publication
(10) Pub. No.: US 2010/0165195 A1
(43) Pub. Date: Jul. 1, 2010

(54) SYSTEM AND METHOD FOR MULTIPLEXED MEASUREMENTS

(75) Inventors: Netanel Ratner, Kiryat-Motzkin (IL); Yoav Yosef Schechner, Haifa (IL)

Correspondence Address: MARTIN D. MOYNIHAN d/b/a PRTSI, INC., P.O. BOX 16446, ARLINGTON, VA, 22215, US

(73) Assignee: Technion Research & Development Foundation Ltd., Haifa (IL)

(21) Appl. No.: 12/450,166

(22) PCT Filed: Mar. 13, 2008
(86) PCT No.: PCT/IL2008/000352

§ 371 Date: Feb. 8, 2010

Related U.S. Application Data
(60) Provisional application No. 60/906,815, filed on Mar. 14, 2007.

(51) Int. Cl. H04N 11/06

(52) U.S. Cl. 348/489; 348/E11.007

(57) ABSTRACT

A method for multiplexing measurements of related values using predetermined numbers of sources having intensities and subject to noise, and at least one sensor subject to saturation, said multiplexing comprising measuring each of said related values under a plurality of different combinations of said sources, the method comprises: generating a first set of multiplexing combinations; constraining said first set with respect to said saturation; modifying said first set with respect to said noise until an optimum is found between respective intensities and noise, and measuring said variables by multiplexing said sources according to said modified set.

### FIELD AND BACKGROUND OF THE INVENTION

The present invention, in some embodiments thereof, relates to a system and method for multiplexed measurements and, more particularly, but not exclusively, to a system or method for providing an optimal multiplexing sequence for given measurements in view of noise or saturation conditions or limitations.

In computer vision research and image-based rendering, objects or people are often acquired under variable lighting directions. Such images are then used for object recognition and identification, rendering, shape estimation and analysis of specularities, shadows and occlusions. Traditionally, such images were taken by moving a light source around the object, or by sequential operation of individual sources in a constellation. However, recently, there is a growing interest in illumination that is not based on single point sources. Rather, it is based on a sequence of images, in each of which lighting may simultaneously arrive from several directions or sources. Some of the benefits include significant improvement in signal to noise ratio (SNR) (See for example FIG. 1), significant reduction of dynamic range problems in the presence of saturated pixels, and convenience when photographing people. Other potential advantages are efficiency of the acquisition process, and image enhancement by simultaneous use of flashes and ambient lighting.

The question is, given all the possibilities of simultaneous operation of sources, what is the optimal way to multiplex the sources in each frame. Y. Y. Scheduler, S. K. Nayar, and P. N. Belhumeur. A theory of multiplexed illumination. In Proc. IEEE ICCV Vol. 2, pages 808-815, 2003, suggest that Hadamard-based codes should be used. However, its analysis does not account for a significant issue, namely that image noise depends on the image irradiance itself, which may make Hadamard multiplexing counterproductive, as is recounted in A.Wenger, A. Gardner, C. Tchou, J. Unger, T. Hawkins, and P. Debevec. Performance relighting and reflectance transformation with time-multiplexed illumination. ACM TOG, 24:756-764, 2005. Fundamentally, photon noise creates such a phenomenon. Photon noise exists in images no matter the quality of the camera, as it stems from the quantum mechanical nature of light.

Moreover, no prior study accounts for saturation of the measurement instrument when seeking optimal measurement. This is despite acknowledgment that saturation and scene dynamic range are important aspects when using multiple sources.

The background art, including items referred to elsewhere herein, includes
[1] A. Agrawal, R. Raskar, S. K. Nayar, and Y. Li. Removing photography artifacts using gradient projection and flashexposure sampling. ACM TOG, 24:828-835, 2005.
[2] F. Alter, Y. Matsushita, and X. Tang. An intensity similarity measure in low-light conditions. In Proc. ECCV Vol. 4, pages 267-280, 2006.
[3] H. H. Barrett and W. Swindell. Radiological Imaging, volume 1. Academic, New York, 1981.
[4] R. Basri and D. Jacobs. Lambertian reflectance and linear subspaces. IEEE Trans. PAMI, 25:218-233, 2003.
[5] D. P. Bertsekas. Nonlinear Programming. Athena Scientific, 1999.
[6] O. G. Cula, K. J. Dana, D. K. Pai, and D. Wang. Polarization multiplexing for bidirectional imaging. In Proc. IEEE CVPR Vol. 2, pages 1116-1123, 2005.
[7] P. Debevec. Image-based lighting. IEEE Computer Graphics and Applications, 22:26-34, 2002.
[8] E. E. Fenimore and T. M. Cannon. Coded aparture imaging with uniformly redundent arrays. Applied Optics, 17:337±347, 1978.
[9] D. Goldman, B. Curless, A. Hertzmann, and S. M. Seitz. Shape and spatially-varying BRDFs from photometric stereo. In Proc. IEEE ICCV, pages 341-348, 2005.
[10] M. Harwit and N.J. A. Sloane. Hadamard Transform Optics. Academic, New York, 1979.
[11] G. Healey and T. O. Binford. Local shape from specularity. In Proc. IEEE ICCV, pages 151-160, 1987.
[12] S. Iou´e and K. R. Spring. Video Microscopy, 2nd ed., 1997. ch. 6,7,8, Plenum Press, New York.
[13] K. C. Lee, J. Ho, and D. J. Kriegman. Acquiring linear subspaces for face recognition under variable lighting. IEEE Trans. PAMI, 27:684-698, 2005.
[14] H. Lensch, J. Kautz, M. Gosele, W. Heidrich, and H. Seidel. Image-based reconstruction of spatial appearance and geometric detail. ACM TOG, 22:234-257, 2003.
[15] M. Levoy, B. Chen, V. Vaish, M. Horowitz, I. McDowall, and M. Bolas. Synthetic aperture confocal imaging. ACM TOG, 23:825-834, 2004.
[16] C. Liu, W. T. Freeman, R. Szeliski, and S. B. Kang. Noise estimation from a single image. In Proc. IEEE CVPR Vol. 1, pages 901-908, 2006.
[17] Q. T. Luong, P. Fua, and Y. Leclerc. Recovery of reflectances and varying illuminants from multiple views. In Proc. ECCV Vol. 3, pages 163-179, 2002.
[18] S. R. Marschner, S. H. Westin, E. P. F. Lafortune, and K. E. Torrance. Image-based bidirectional reflectance distribution function measurement. Applied Optics, 39:2592-2600, 2000.
[19] W. Matusik, H. Pfister, A. Ngan, P. Beardsley, R. Ziegler, and L. McMillan. Image-based 3D photography using opacity hulls. ACM TOG, 21:427-437, 2002.
[20] F. Moreno-Noguer, S. K. Nayar, and P. N. Belhumeur. Optimal illumination for image and video relighting. In Proc. IEE Conf. Visual Media Production, pages 201-210,2005.
[21] Y. Moses, S. Ullman, and S. Edelman. Generalization to novel images in upright and inverted faces. Perception, 25:443-461, 1996.
[22] G. Nitzsche and R. Riesenberg. Noise, fluctuation and HADAMARD-transform-spectrometry. In Proc. SPIE, volume 5111, pages 273-282,2003.
[23] M. Osadchy and D. Keren. Efficient detection under varying illumination conditions and image plane rotations. Computer Vision & Image Understanding, 93:245-259, 2004.
[24] J. A. Paterson, D. Claus, and A. W. Fitzgibbon. BRDF and geometry capture from extended inhomogeneous samples using flash photography. In Proc. Eurographics, 2005.
[25] R. Ramamoorthi and P. Hanrahan. Frequency space environment map rendering. ACM TOG, 21:517-526, 2002.
[26] R. Raskar, K. H. Tan, R. Feris, J. Yu, and M. Turk. Nonphotorealistic camera: depth edge detection and stylized rendering using multiflash imaging. ACM TOG, 23:679-688, 2004.
[27] I. Sato, T. Okabe, Y. Sato, and K. Ikeuchi. Using extended light sources for modeling object apperance under varying illumination. Proc. IEEE ICCV, pages 325-332,2005.
[28] Y. Y. Schechner, S. K. Nayar, and P. N. Belhumeur. A theory of multiplexed illumination. In Proc. IEEE ICCV Vol. 2, pages 808-815,2003.
[29] Y. Y. Schechner, S. K. Nayar, and P. N. Belhumeur. Multiplexing for optimal lighting. IEEE Trans. PAMI, to be published, 2007.
[30] P. Sen, B. Chen, G. Garg, S. R. Marschner, M. Horowitz, M. Levoy, and H. P. A. Lensch. Dual photography. ACM TOG, 24:745-755, 2005.
[31] A. Shashua. On photometric issues in 3D visual recognition from a single 2D image. Int. J. Comp. Vis., 21:99-122, 1997.
[32] T. Sim, S. Baker, and M. Bsat. The CMU pose, illumination and expression database. IEEE Trans. PAM!, 25:1615-1618, 2003.
[33] G. K. Skiner. X-ray imaging with coded masks. Scientific American, 259:84-89, 1988.
[34] A. Wenger, A. Gardner, C. Tchou, J. Unger, T. Hawkins, and P. Debevec. Performance relighting and reflectance transformation with time-multiplexed illumination. ACM TOG, 24:756-764, 2005.
[35] A. Wuttig. Optimal transformations for optical multiplex measurements in the presence of photon noise. Applied Optics, 44:2710-2719, 2005.
[36] A. Yuille, J. M. Coughlan, and S. Konishi. The KGBR viewpoint-lighting ambiguity. JOSA A, 20:24-31, 2003.
[37] T. Zickler. Reciprocal image features for uncalibrated helmholtz stereopsis. In Proc. IEEE CVPR Vol. 2, pages 1801-1808, 2006.

### SUMMARY OF THE INVENTION

The present embodiments may provide optimal ways of multiplexing measurements for given numbers of measurement variables, a given saturation level and a given noise model.

According to an aspect of some embodiments of the present invention there is provided a method for multiplexing measurements of related values using predetermined numbers of sources having intensities and subject to noise, and at least one sensor subject to saturation, the multiplexing comprising measuring each of the related values under a plurality of different combinations of the sources, the method comprising:

generating a first set of multiplexing combinations;

constraining the first set with respect to the saturation;

modifying the first set with respect to the noise until a balance is found between respective intensities and noise, and

measuring the variables by multiplexing the sources according to the modified set. In an embodiment, the balance comprises an optimization.

In an embodiment, the optimization comprises minimizing any one member of the distance functions comprising: mean square error, and weighted mean square error.

An embodiment may comprise using a noise model to model the sensor noise.

An embodiment may comprise projecting the noise model with the constraints onto a graph to form a hyperplane.

In an embodiment, the optimizing comprises finding a minimum within the hyperplane.

In an embodiment, the finding a minimum within the hyperplane comprises stepping through the hyperplane until a first minimum is reached and then iteratively perturbing the stepping to search for a bigger minimum, thereby to arrive at a global minimum.

In an embodiment, the sources are illumination sources.

In an embodiment, the illumination sources are any one of the group consisting of visible light sources, infra-red sources, ultra-violet sources, x-ray sources, pinhole sources, spatial pinholes, slots, temporal slots, varying aperture pinhole sources, coded aperture pinhole sources, single-wavelength sources, reflective sources, radar sources, and sources defined by gating intervals of a reflected signal.

In an embodiment, the generating the first set comprises using random values.

In an embodiment, intensity of respective sources is variable and wherein the generating the first set and the modifying both comprise defining source intensity values.

An embodiment may comprise constraining the first set to any member of the group of domains consisting of the real-valued domain, the non-negative domain, and the binary domain.

According to a second aspect of the present invention there is provided a method for multiplexing measurements of related values using predetermined numbers of sources having intensities and subject to noise, and at least one sensor subject to saturation, the multiplexing comprising measuring each of the related values under a plurality of different combinations of the sources, the method comprising:

generating a first set of multiplexing combinations;

constraining the first set with respect to the saturation;

modifying the first set with respect to the noise until an optimum is found between respective intensities and noise, and

outputting the modified set as a measurement sequence for measuring the variables by multiplexing the sources thereby.

According to a third aspect of the present invention there is provided a method for multiplexing measurements of related values using predetermined numbers of wavelength sources, having respective wavelengths intensities and subject to noise, and at least one sensor subject to saturation, the multiplexing comprising measuring each of the related values under a plurality of different combinations of the sources, the method comprising:

generating a first set of multiplexing combinations;

constraining the first set with respect to the saturation;

modifying the first set with respect to the noise until an optimum is found between respective intensities and noise, and

operating a filter according to the modified set to multiplex the sources.

In an embodiment, the filter is a fixed filter constructed according to the set.

In an embodiment, the filter is a tunable filter. operating comprises tuning a tunable filter according to the set.

In an embodiment, the tunable filter is any member of the group comprising a tunable spectrum filter, a liquid crystal tunable spectral filter, and a dispersive element with a tunable output.

According to a fourth aspect of the present invention there is provided a method for multiplexing measurements of related values using predetermined numbers of sources having intensities and subject to noise, and at least one sensor subject to saturation, the multiplexing comprising measuring each of the related values under a plurality of different combinations of the sources, the method comprising:

generating a first set of multiplexing combinations;

modifying the first set with respect to the noise until an optimum is found between respective intensities and noise, and

measuring the variables by multiplexing the sources according to the modified set.

According to a fifth aspect of the present invention there is provided a method for multiplexing measurements of related values using predetermined numbers of sources having intensities and subject to noise, and at least one sensor subject to saturation, the multiplexing comprising measuring each of the related values under a plurality of different combinations of the sources, the method comprising:

generating a first set of multiplexing combinations;

constraining the first set with respect to the saturation; and

measuring the variables by multiplexing the sources according to the modified set.

According to a sixth aspect of the present invention there is provided apparatus for multiplexing measurements of related values using predetermined numbers of sources having intensities and subject to noise, and at least one sensor subject to saturation, the multiplexing comprising measuring each of the related values under a plurality of different combinations of the sources, the apparatus comprising:

a sequence generator configured to generate a first set of multiplexing combinations;

a constrainer configured for constraining the first set with respect to the saturation;

an iterative modifier configured for modifying the first set with respect to the noise until an optimum is found between respective intensities and noise, and

a measurement unit configured for measuring the variables by multiplexing the sources according to the modified set.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is an image taken under a single light source according to the trivial case known in the prior art;

FIG. 1B is an image of the same scene, decoded from images illuminated by 57 multiplexed sources. It is decoded as if illuminated by the same single source, and the multiplexing code may be optimized using the presently preferred embodiments;

FIG. 1C is a flow chart showing a process according to a first embodiment of the present invention;

FIG. 1D is a flow chart showing apparatus for carrying out the procedure of FIG. 1C;

FIG. 1E is a simplified flow chart showing an initialization procedure for optimization of multiplexing of a measurement, according to a preferred embodiment of the present invention;

FIG. 1F is a simplified flow chart showing a minimization procedure for finding a minimum of the measurement problem according to a preferred embodiment of the present invention;

FIG. 1G is a simplified flow chart showing iteration of the minimization procedure of FIG. 1D in order to break out of local minima and find a global minimum for overall optimization;

FIG. 2 is a graph showing noise calibration 0-47 sources, and showing how noise varies linearly with the number of sources;

FIG. 3 is a two-dimensional illustration of the optimization task according to the present embodiments with the shaded area indicating the saturation constraints within a hyperplane;

FIG. 4 illustrates the expected multiplex gain for various values of χ2. Here N=57, thus C □{2, . . . , 29}. The solid line corresponds to the system of the present embodiments and the values of Cₒₚₜ are marked by asterisks. They shift as the photon noise increases relative to κ²_{gray};

FIG. 5 is a diagram showing the hyperplane of FIG. 3 and illustrating how the optimization procedure may get stuck at a local minimum;

FIGS. 6A and 6B are diagrams illustrating two multiplex codes for measuring at different sampling levels in accordance with embodiments of the present invention;

FIG. 7 is a graph illustrating comparative results of the codes of FIG. 6A, of Wuttig and of the trivial measuring;

FIGS. 8A and 8B are illustrations of the experimental results of illuminating a scene with trivial and optimal multiplexing respectively ; and

FIGS. 9A and 9B are MSEs of the images decoded from illumination multiplexed frames. FIG. 9A illustrates the case of N=11. Hadamard multiplexing becomes counter productive for high gray levels. FIG. 9B shows the slightly artificial case of using Hadamard and plotting only unsaturated pixels.

### DESCRIPTION OF EMBODIMENTS OF THE INVENTION

The present invention, in some embodiments thereof, relates to a system and method for multiplexed measurements and, more particularly, but not exclusively, to a system or method for providing an optimal multiplexing sequence for given measurements in view of noise or saturation conditions or limitations.

Taking a sequence of photographs using multiple illumination sources or settings is central to many computer vision and graphics problems. A growing number of recent methods use multiple sources rather than single point sources in each frame of the sequence. Potential benefits include increased signal-to-noise ratio and accommodation of scene dynamic range. However, existing multiplexing schemes, including Hadamard-based codes, are inhibited by fundamental limits set by Poisson distributed photon noise and by sensor saturation. The prior schemes may actually be counterproductive due to these effects. The present embodiments derive multiplexing codes that are optimal under these fundamental effects. Thus, the novel codes generalize the application of the prior schemes and have a much broader applicability.

The present approach is based on formulating the problem as a constrained optimization. We further suggest an algorithm to solve this optimization problem. The superiority and effectiveness of the method is demonstrated in experiments involving object illumination.

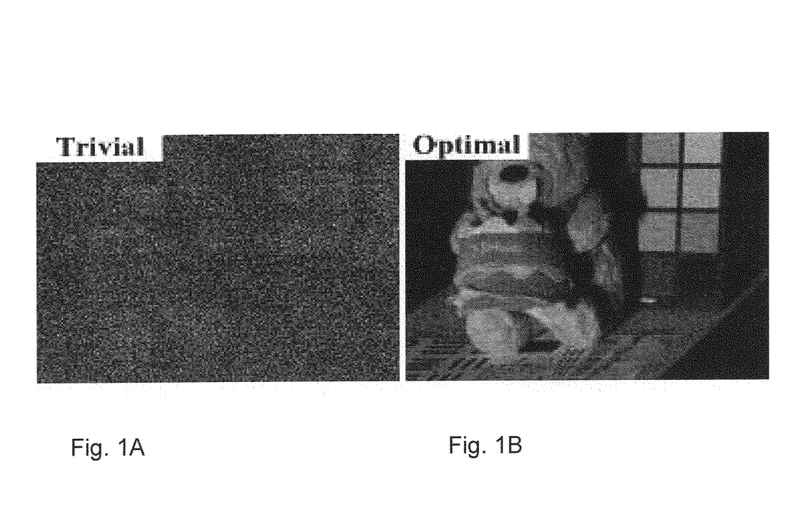

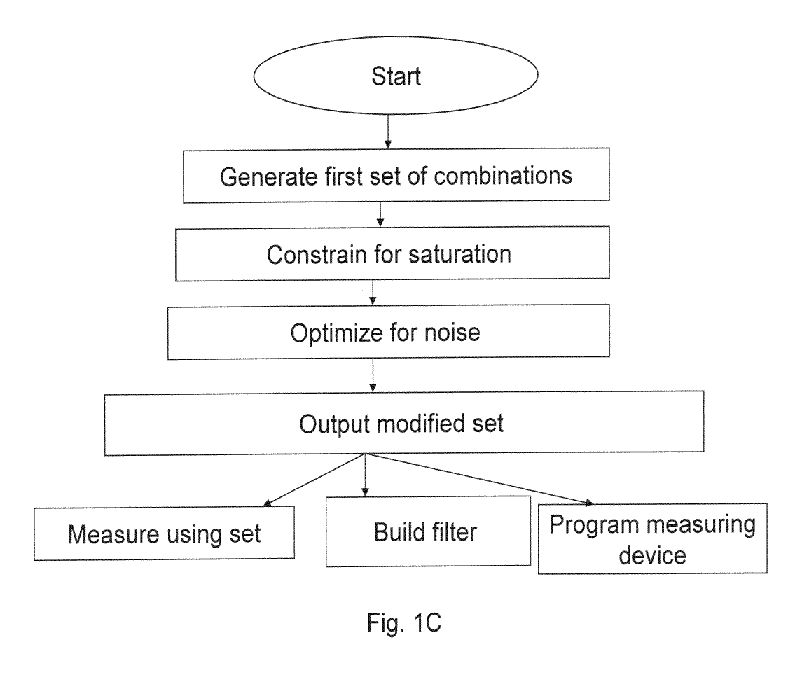

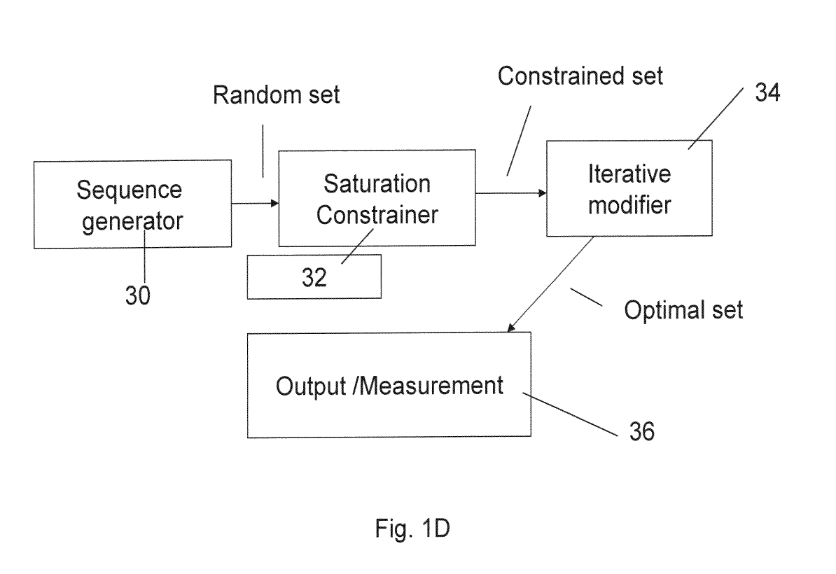

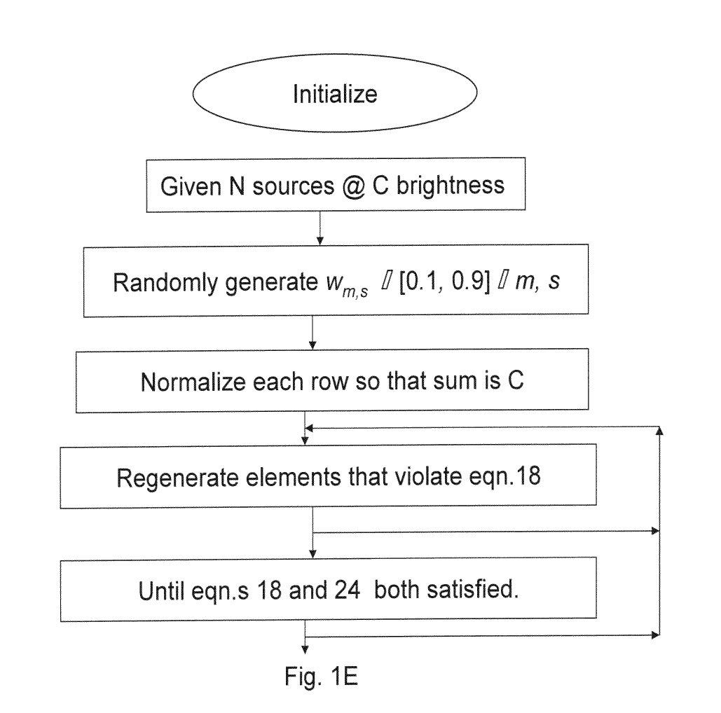

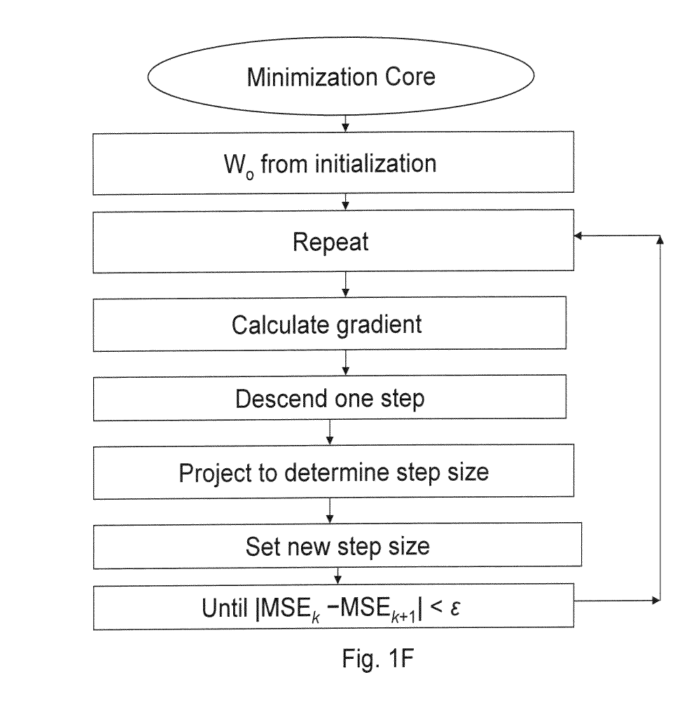

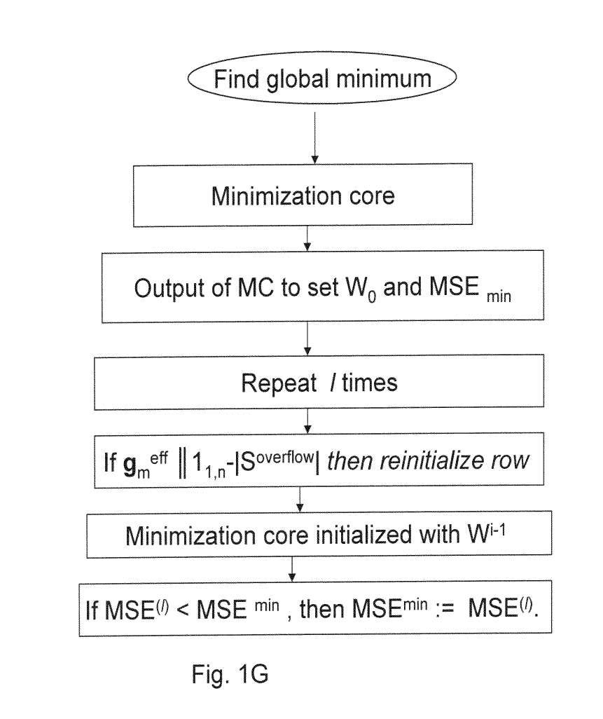

For purposes of better understanding some embodiments of the present invention, as illustrated in FIGS. 1B . . . 9B of the drawings, reference has already been made to conventional single point (i.e., prior art) measurement as illustrated in FIG. 1A.

The present embodiments seek and provide multiplexing codes that are optimal under the fundamental limitations of photon noise and saturation, in addition to camera readout noise. This problem and its solution have implications much broader than computer vision and graphics. The reason is that multiplexing of radiation sources is used in many sensing modalities, such as X-ray imaging, spectroscopy, coded-aperture imaging, and communication in fiber optics.

Hence, the approach presented here has wide applicability. It is based on a constrained optimization formulation. We also describe an algorithm for solving this problem. The resulting novel codes are superior to prior multiplexing codes.

We demonstrate this in experiments of object lighting.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Referring now to the drawings, FIG. 1C is a simplified diagram showing a a process according to a first embodiment of the present invention. FIG. 1C shows a method for multiplexing measurements of related values using predetermined numbers of sources. The same procedure may be followed whatever the number of sources but the procedure is followed in any given instance for a particular number of sources. The sources may have controllable or fixed intensities. If the intensity is controllable then the intensity may become one of the parameters that is optimized in the procedure below. The sources are subject to noise, and the noise typically grows with the number of sources. A model of the noise behavior may be available.

Sensing is carried out using one or more sensors, but the sensor is subject to saturation, so that simply illuminating the object more brightly eventually ceases to be of benefit since all that is achieved is to saturate the sensor or the sample, or in the case of fluorescent dye of the maximum amount of radiation that produces an additional affect on the dye. Furthermore the system may be constrained by the amount of radiation it is safe to apply to the specimen. The sources may be multiplexed together in a sequence of ways to carry out the measurement so that the overall measurement makes use of different combinations of the sources. The optimal sequence is obtained by firstly generating a first set of multiplexing combinations. This first set may be generated at random, or may be based on an educated guess.

The set is then constrained so that brightness is limited to ensure that saturation of the sensor or sensors does not occur.

There follows a process of modifying the first set with respect to the noise until an optimum is found between the intensities and noise. That is to say illumination increases the more sources are used, and this is helpful until saturation is reached. However, all additional illumination may increase the amount of noise since noise is additive. Noise such as photon noise is random and cannot be accounted for by noise reduction techniques so that optimization is needed to balance between illumination and noise. Optimization may be iterative, as will be explained in greater detail below

Finally, as shown in the figure, the variables are measured by multiplexing the sources according to the modified set.

As mentioned, the method may comprise using a noise model to model the sensor noise. Optimization may involve projecting the noise model with the saturation constraints onto a graph to form a hyperplane. Then, optimizing comprises finding a minimum within the hyperplane. The minimum may be a global or a local minimum, and the global minimum may be found by stepping through the hyperplane until a first minimum is reached and then iteratively perturbing the stepping process to search for a bigger minimum. Each time a larger minimum is found it is set as the current minimum and a set number of iterations are carried out, the global minimum being taken to be the current minimum that is set at the end of the process.

The sources may be illumination sources, for example visible light sources, infra-red sources, ultra-violet sources, x-ray sources, pinhole sources, varying aperture pinhole sources, coded aperture pinhole sources, single-wavelength sources, reflective sources, radar sources, and sources defined by gating intervals of a reflected signal.

Regarding light sources, one possible application of the present embodiments is in fluorescent microscopy. The object contains fluorescent dies, which are illuminated by incident radiation to give off their own light at other wavelengths. The different wavelengths may be treated as the different variables.

The initial generating may be made using randomly selected values. In some cases, the intensity of the illumination sources is variable and can be controlled. In such a case a parameter may be used for each source to define the intensity.

Reference is now made to FIG. 1D which shows apparatus for carrying out the method of FIG. 1C. The apparatus comprises a sequence generator 30 configured to generate a first set of multiplexing combinations, typically a random set. A constrainer 32 constrains the first set with respect to sensor saturation to produce a constrained set. Iterative modifier 34 modifies the constrained set with respect to the noise until an optimum is found between respective intensities and noise. Finally an output is produced which may be used to set up a measurement procedure or may be used directly in measurement by output/measurement unit 36.

Reference is now made to FIG. 1E which shows the initialization process for N sources at C brightness. First a set of multiplexed measurements W_{m,s} is randomly generated. Each row is normalized to give a sum of C. Then a loop of eliminating elements is followed until the brightness constraint—no saturation—is satisfied.

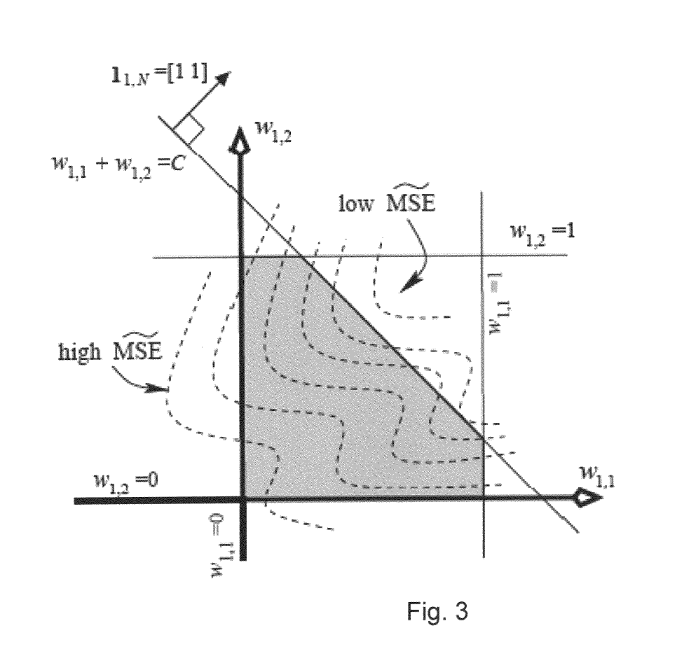

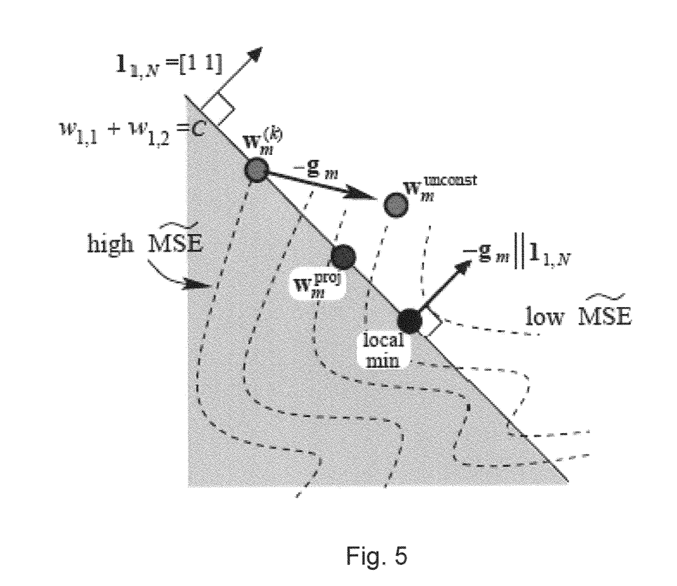

FIG. 1F shows the minimization core, referred to in greater detail below. In the minimization core a set of multiplexed measurements is accepted from the initialization procedure but is far from being optimized. The noise model has been projected onto the hyperplane of FIG. 3 to form FIG. 5 and minimization is of W within the constraints the shaded area of the figures. A point is taken and the gradient calculated. The gradient is followed in steps and the step size adjusted until a minimum is found.

FIG. 1G shows the overall procedure within which the others lie. The minimum found by the minimization core in FIG. 1F may be a local minimum, so each time a result is obtained the input is perturbed and the procedure repeated. If the repeat produces a better minimum then that better minimum is set as the new minimum. The operation is repeated a set number of times l and the minimum remaining at the end is taken to be the global minimum.

Theoretical Background

The above procedure is now treated from a theoretical point of view.

Multiplexing

Consider a setup where N light sources illuminate an object from various directions. Let i=(i₁, i₂, . . . , i_{N})^{t} be a set of intensity values of a certain pixel, where each value corresponds to illumination by any individual light source in this setup. Here t denotes transposition.

In general, several light sources can be turned on at a time (multiplexing). Define an N′N multiplex matrix W, often referred to as a multiplexing code. Each element of its mth row represents the power of the corresponding illumination source in the mth measurement. The power is measured relative to its maximum value, where 0 states that the source is completely off and 1 indicates a fully activated source. The measurements acquired at each pixel are denoted by the vector

a=(a₁, a₂, . . . , a_{N})^{t}.

Using the above notation the power is given by

a=Wᵢ+ν, (1)

where ν is the measurement noise. Any bias to this noise is assumed to be compensated for. The noise ν is assumed to be uncorrelated in different pixels, with variance of a σ²ₐ.

Once images have been acquired under multiplexed illumination, they can be demultiplexed computationally, to derive estimates for the pixel values under single-source illumination ̂i. The best linear estimator in the sense of mean square error (MSE) for the single source images is

̂I=W⁻¹a. (2)

The MSE of this estimator is

$${MSE}_{\hat{} i} = \frac{{σ}_{a}^{2}}{N} trace [ {( {W}^{t} W )}^{- 1} ] \qquad ( 3 )$$

The MSE as above is the expected noise variance of the recovered images. The lower it is, the better the SNR. The SNR is defined as the ratio between the expected ̂i and _√(MSÊi). Without multiplexing, W is the identity matrix (trivial sensing: only a single source is on at a time). The improved SNR by multiplexing, relative to the SNR without multiplexing

G=SNR_{Multiplexed}/SNR_{Single} (4)

is the multiplex gain.

Noise Mechanisms

To analyze the effect of multiplexing, we may first understand the sources of image noise. In this section we briefly review the affine noise model. Affine noise exists in high grade detectors, which have a linear radiometric response. The noise can be divided into two components, signal-dependent and signal-independent. Regardless of the photon flux, signal-independent noise is created by dark current, amplifier noise and the quantizer in the camera circuity.

Denote the graylevel variance of the signal-independent noise by κ²_{gray}.

Fundamental signal-dependent noise is related to two random effects. The photon flux and the uncertainty of the electron-photon conversion process which occurs in the detector. However there may be other non-fundamental—signal dependent—noise effects that may also be involved. Overall, the random number n_{electr}^{photo} of photogenerated electrons is Poisson distributed. In this distribution, the variance of n_{electr}^{photo} is

VAR(n_{electr}^{photo})=ε(n_{electr}^{photo}), (5)

where ε denotes expectation. This variance linearly increases with the measured electric signal n_{electr}^{photo}. This is photon noise. The number of detected electrons n_{electr}^{photo} is proportional to the gray-level of the acquired pixel value a

a=n_{electr}^{photo}Q_{electr}. (6)

Here Q_{electr} is the number of photo-generated electrons required to change a unit gray-level. Typically Q_{electr}>>1.

Combining Eqs. (5,6) yields a variance in gray levels

ε(n_{electr}^{photo})/Q²_{electo}=a/Q_{electr}. (7)

Compounded with signal-independent noise, the total noise variance of the measured gray level is

σ²ₐ=κ²_{gray}+a/Q_{electr}. (8)

Now, consider a diffuse object and sources that illuminate the object from similar directions. In this case, each light source yields a similar object radiance, hence, a similar level of noise. In each measurement, let C sources be activated, each at maximum power. We rephrase Eq. (8) as

σ²ₐ=κ²_{gray}+Cη². (9)

Here η² is the photon noise variance, induced by object irradiance from a single source turned on completely. Eq. (9) is an affine function of the number of active sources C.

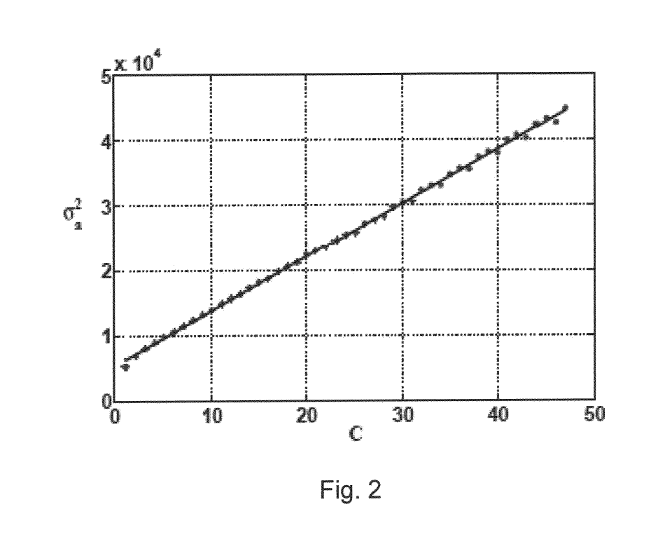

Reference is now made to FIG. 2, which is a graph showing noise calibration as a function of the number of sources from 0 to 47. In our system, the noise variance linearly increases with the number of activated sources C, in agreement with the affine noise model. More particularly, FIG. 2 plots the average noise variance in raw images acquired by a PtGrey Dragonfly camera. In each measurement, C light sources were activated. The dynamic range of the 16-bit raw data was a □[0, 65535] graylevels, while σa □[70, 220] graylevels. Fitting a straight line to this plot yields κ²_{gray} and η².

Photon Noise and Multiplexing

A well known multiplexing code is based on Hadamard codes. Its multiplex matrix is known as the S-matrix. Here C=(N+1)2. The MSE obtained using this code is

$${MSE}_{\hat{} i , Had} = \frac{4 N}{( N + {1}^{2} )} {σ}_{a }^{2} \qquad ( 10 )$$

Using Eq. (9) with C=(N+1)/2, Eq. (10) yields

$${MSE}_{\hat{} i , Had} = \frac{4 N}{( N + {1}^{2} )} {κ}_{gray}^{2} + \frac{2 N}{( N + 1 )} {η}^{2} \qquad ( 11 )$$

In the special case where the photon noise is negligible, i.e.

κ²_{gray}>>Cη², Eq. (10) becomes:

$${MSE}_{\hat{} i , Had} = \frac{4 N}{( N + {1}^{2} )} {κ}_{gray}^{2} \qquad ( 12 )$$

and the corresponding SNR gain is

$$GHad = \frac{{SNR}_{Hadamard}}{{SNR}_{Single}} = \frac{N + 1}{2 \sqrt{N}} . \qquad ( 13 )$$

Hence, in such a scenario, Hadamard multiplexing is highly beneficial. The S-matrix is optimal, minimizing Eq. (3).

On the other hand, when photon noise dominates, then

Cη²>>κ²_{gray}. In this case, Eq. (11) indicates that the demultiplexed images {̂i} are more noisy than those obtained by simple single-source acquisition. The noise variance doubles by this process, if N>>1. The reason is that increasing the signal by multiplexing light sources increases the photon noise as well.

A. Wuttig. Optimal transformations for optical multiplex measurements in the presence of photon noise. Applied Optics, 44:2710-2719, 2005, looked into the problem of multiplexing under photon noise. It formulated a general expression for the multiplex gain under the affine model of Eq. (5):

$$G = {G}_{0} Z\_where \_Z = \sqrt{\frac{1 + {χ}^{2}}{1 + C {χ}^{2}}} \qquad ( 14 )$$

where

χ=η/κ_{gray}. (15)

Here,

G0=√{N/trace_[(W^{t}W)⁻¹]} (16)

is the multiplex gain when photon noise is not considered. Note in Eqn. 14 Z may change if the affine model is not in force.

Hence, for a given characteristic χ of the noise, G in Eq. (14) is maximized by reducing C while increasing G₀. Wuttig above proposed multiplexing codes, which optimize G out of the set of cyclic binary matrices W, hence they are not general multiplexing matrices. Moreover, these codes, termed perfect sequences, exist only for a very limited set of N and noise parameters. For most values of χ and N, perfect sequences do not exist.

Optimal Saturated Multiplexing

We begin the discussion by considering saturation. While an object may be moderately bright when illuminated by a single source, it can become saturated if illuminated by numerous light sources. When this is the case, multiplexing too many sources, e.g. using the S-matrix is impractical.

While exposure time may be reduced to counter saturation, such a step should be avoided. It is generally better to decrease the number of illumination sources C activated in each measurement. This raises the need for new multiplexing codes that comply with a constraint on C.

Assume that the saturation phenomenon is insensitive to the specific identities of the illuminating sources. Saturation is assumed to occur when the total illumination radiance exceeds a threshold, Cₛₐₜ. If all light sources yield a similar object radiance, then Cₛₐₜ expresses units of light sources, and is analogous to C hereinabove.

Saturation is avoided if

$${\sum }_{S = 1}^{N} {ω}_{m , s} \leq {C}_{Sat} • m • \{ 1 , 2 , … , N \} . \qquad ( 17 )$$

Recall that all sources can be activated with some portion

of their maximum intensity i.e.

0≦w_{m,s}≦1□m, s□{1, 2, . . . N}. (18)

We use Eq. (16) to formulate a maximization problem on the multiplex gain, G₀. In this section, we do not consider photon noise. Hence, a signal-dependency of the noise is not used here. Maximizing G₀ is equivalent to minimizing its reciprocal square i.e.

$$\begin{matrix}arg {max}_{W} {G}_{0} ≡ arg {min}_{W} \frac{1}{{G}_{0}^{2}} \\ = arg {min}_{W} \frac{1}{N} trace [ {( {W}^{t} W )}^{- 1} ] .\end{matrix} \qquad ( 19 )$$

The constraints for our problem are taken from Eqs. (17,18).

Thus, the optimization problem is

$$\begin{matrix}{min}_{W} \frac{1}{N} trace [ {( {W}^{t} W )}^{- 1} ] & ( 20 ) \\ \begin{matrix}s . t . {1}_{1 , N} \cdot {w}_{m} - {C}_{Sat} \leq 0 & ∀ m ∈ \{ 1 , … , N \} \\ - {w}_{m , s} \leq 0 & ∀ m , s ∈ \{ 1 , … , N \} \\ {w}_{m , s} - 1 \leq 0 & ∀ m , s ∈ \{ 1 , … , N \} .\end{matrix} & \begin{matrix}\begin{matrix}( 21 ) \\ ( 22 )\end{matrix} \\ ( 23 )\end{matrix}\end{matrix}$$

Here 1_{1,N} is a row vector, all of whose elements are 1 and

wₘ is the m′th row of W. Reference is here made to FIG. 3 which is a two-dimensional illustration of the optimization task. The shaded area is the domain in which w₁ satisfies the constraints.

This problem is simple if Csat>(N+1)/2. In this case, codes based on the S-matrix are optimal. The reason is that saturation is not met in Hadamard multiplexing when Csat>(N+1)/2. Hence, the optimality of Hadamard codes holds in this case.

We thus focus on Csat≦(N+1)/2. Simulations we performed found local minima in equation (20). The best minimum occurred when equation (21) was active. This may be intuitively explained by arguing that one prefers to exploit the maximum radiance for every measurement. It is noted that this argument holds if the noise is signal independent. The more general case is discussed hereinbelow. We therefore replace Eq. (21) by the equality constraint

1_{1,N}·wₘ=Cₛₐₜ□m□{1, 2, . . . , N}. (24)

While using Csat in Eq. (24) facilitates optimization under saturation, for the remainder of the work we favor the use of C instead. This is done to allow a subsequent generalization of the formulation to photon noise. Note that Eq. (24) means that wₘ must lie on a hyperplane (see FIG. 3), whose unit normal vector is (1/√N)1^{t}_{1,N}.

Optimal Photon Limited Lighting

The previous section considered only saturation. We now extend the approach

to cope with photon noise. Solving the optimization problem in Eq. (20) subject to the constraints results in an illumination matrix W(C), that is optimal, for a given C. In other words, we determine the values in each row wₘ of W(C), such that 1_{1,N}·wₘ is exactly C, while W(C) has the highest gain, G₀, under a signal-independent noise model. Eq. (14) then converts G₀ to the multiplex gain under the general affine noise model. It is noted that there is no point in checking cases where C≧(N+1)/2. They are certainly suboptimal, for a given N, as we now explain. Recall that for signal-independent noise and no saturation, G is optimized by the S matrix. From (14) it can also be seen that if G₀ is optimized, there is no point in increasing C, as it will only degrade G.

Recall that χ² can be obtained from calibration, as described hereinabove in connection with Eq. (15). Based on χ² and G₀(W(C)), Eq. (14) yields the multiplexing gain G(C).

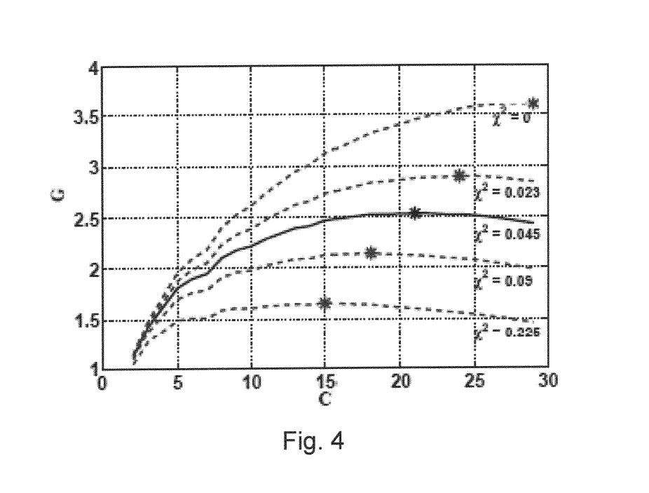

Now, let a range of values of C be scanned. For each C, we obtain W(C), as well as G(C). This function G(C) is plotted in FIG. 4, for actual results obtained by our algorithm. Out of the plot, the value of C that maximizes G is selected. In other words, this scan finds the number of activated sources per measurement that maximizes the gain, accounting for photon noise (via Eq. 14), and the system characteristic x. The above yields the following procedure:
1. Calibrate the system to find χ².
2. Scan the range of C values from 1 to Cₛₐₜ. For each value of C, perform the subsequent steps 3 and 4.
3. Find the matrix W(C) that optimizes Eq. (20) subject to Eqs. (22,23,24).
4. Calculate the expected multiplex gain G(C) using Eqs. (14,16).
5. Let Copt=argmaxC G(C), as in FIG. 4.
6. The desired multiplexing code is W(Copt).

It is noted with respect to step 2 above that there is no necessity for exhaustive search of G(C). Since G(C) is well behaved, one can incorporate efficient optimization procedures.

It is noted that if the noise is not affine then the optimization process is the same except that the calibration in stage 1 is different and in stage 4, the Z of equation 14 is different.

Minimization Procedure

We now describe a numerical scheme for solving the system given in Eqs. (20,22,23,24). It consists of a core, which is based on a projected gradient method. It also consists of a higher-level procedure, designed to escape local minima. We define

$$= \frac{1}{{σ}_{a}^{2}} {MSE}_{\tilde{i}} ( W ) = \frac{1}{N} trace [ {( {W}^{t} W )}^{- 1} ] . \qquad ( 25 )$$

We iteratively minimize_: [symbol] as a function of W. The minimization core is based on projected gradient descend. In each basic step, W is updated by the gradient

$$Γ {=}^{Δ} \frac{d}{d W} = - \frac{2}{N} {( {W}^{t} {WW}^{t} )}^{- 1} . \qquad ( 26 )$$

The updated W is then projected onto constraints (18) and (24), one at a time. This is illustrated in FIG. 5, which is a simplified diagram showing how optimization may get stuck at a local minimum or may avoid such. In FIG. 5, from dot wm, the gradient descent yields dot w^{unconst}ₘ. The latter is projected into the constraint (24), yielding w^{pro}jₘ. When the gradient gm is normal to the constraint surface, then w^{proj}ₘ=the dot wₘ. Hence, the optimization gets stuck at a local minimum.

Further details are given in the section minimization core hereinbelow.

The_MSE in Eq. (20) is a multimodal function of W. Therefore, the core generally converges to a local minimum, rather than a global one. To escape local minima, we embed the core in a higher level process. When the core converges to a local minimum, W is modified, as we describe below.

Then, the core is re-initialized with the modified W. The minimization core gets stuck in a local minimum because specific rows of W are prevented from undergoing any modification. This prevention is caused by the constraints.

To understand this, note that Eq. (26) is never nulled. Indeed A valid inverse of a matrix A can never be nulled. If it could, it would have yielded a contradiction: A⁻¹A=I_{N×N}=0_{N×N}A, where 0_{N×N} is an N×N null matrix.

Hence, following the Karush-Kuhn-Tucker theorem, all of the extrema of_ [symbol] are obtained when constraints are active. For this reason, local minima are caused by matrix rows which reside on constraints, as illustrated in FIG. 5. On the other hand, other rows of W are free to change. We therefore seek to identify rows that stagnate the minimization core.

The m′th row of W is wₘ. Its corresponding row in the gradient matrix Γ is gₘ. When gₘ is parallel to 1_{1,N}, it means that this row of the gradient is orthogonal to the constraint surface (24), as illustrated in FIG. 5. If this is the case, then wₘ is equivalent to its projection, stagnating the minimization core. Hence, a sufficient condition of row m of W to stagnate is that gₘ∥1_{1,N}.

While the above condition is sufficient, it is not a necessary one. We now describe a wider class of stagnating rows. Suppose that wₘ has elements s for which w_{m, s}=1 or 0 and that wₘgₘ shifts them beyond the bounds of Eqs. (22,23). Denote the set of indices of these elements by S^{overflow}. Now, define a row vector

gₘ^{eff}□R^{N-|S}^{^{overflow}}|

It is extracted from gm, and defined as

$${g}_{m}^{eff} {=}^{Δ} {g}_{m , s} ∉ {S}^{overflow} .$$

Hence, it consists only of those elements s in gm whose indices are not in S^{overflow}. It can be shown that

gₘ^{eff}∥1_{1,n}−|S^{overflow}| (27)

is a necessary condition for stagnation of row m.

An algorithm is intended to detect a local minimum of the core, and then escape it, as follows:

1. Execute the minimization core discussed hereinbelow once.

Use its output multiplexing code and corresponding _MSE to initializeWₒ and [symbol] ₘᵢₙ.

2. Iterate the subsequent steps 3,4,5 until the number of allowed iterations is exhausted. The iteration index is 1.

3. For all m □{1, . . . , N}, if Eq. (27) holds, then row m is detected as stagnated. Replace it by a random row vector. This new row complies with (18,24) and is formulated as described in App. B.

4. Execute the minimization core again. Initialize it by W(l−1). Its output is W(l), as well as [symbol] (l)

and its corresponding gradient Γ(l).

5. If [symbol] (l)< [symbol] ₘᵢₙ, then [symbol] ₘᵢₙ:= [symbol] (l).

Minimization Core

Returning now to FIG. 1F, in the following minimization core k is an iteration variable, and the idea is to minimize_MSE as a function of W.
1. Given N and C, we create an initial matrix W₀ (See Initiation below). The initial matrix W₀ complies with constraints (22,23,24) above.
2. Repeat the subsequent stages 3 and 4, until |MSEₖ−MSEₖ₊₁|<ε, where Eis a pre-determined small threshold.
3. Calculate the gradient, Γk (Eq. 26). Then, calculate an updated matrix Wₖ₊₁^{unconst}\hat{=}wₖ−Γₖ, as in standard gradient descent (FIG. 5). We take care of the step size in stage 4.
4. Project Wₖ₊₁^{unconst} in the following way:

(i) Project Wₖ₊₁^{unconst} onto the hyperplane used in (24) as in FIG. 5. It is easy to show that for each row wₘ^{unconst} its projection is

$${w}_{m}^{proj} = {w}_{m}^{unconst} + [ C - {\sum }_{s = 1}^{N} {w}_{m , s}^{unconst} ] \frac{{1}_{1}^{t} N}{N} . \qquad ( 28 )$$

(ii) Denote dₖ\hat{=}Wₖ₊₁^{proj}−wₖ. Then, update Wₖ₊₁^{unbounded}=Wk−βdₖ, where β is a parameter controlling the step size.
(iii) Project Wₖ^{unbounded} onto constraints (22,23) to

Create Wₖ₊₁. This is done by truncating the elements Of Wₖ₊₁^{unbounded} to [0, 1].

Initialization of the Minimization Core

Returning now to FIG. 1E, we now describe the initialization procedure for the initial matrix W₀. We randomly generate w_{m,s} □[0.1, 0.9] □m, s. This avoids activation of constraints (22,23) in this step. We then normalize each row, m of W₀ such that its sum is C. Any element violating equation (18) is regenerated and the normalization process is then repeated until satisfaction of Eqs. (18, 24).

Experiments

We demonstrate the new multiplexing codes by applying them to lighting. An EPSON EMP-7800 projector created patterns of light patches on a white diffuse wall. Light reflected by these patches acted as distinct sources irradiating the viewed objects. The exposure time of the Dragonfly camera was 63 msec, corresponding to a 15 Hz frame rate. It eliminates radiance fluctuations of the projector, which has a period of 7 msec.

Calibration

For noise calibration, images of the object were taken, by simply turning on C of the N illumination sources. For each value of C, a sequence of 10 frames was taken. From this sequence, the noise variance σ²ₐ(x, y, C) was estimated per pixel (x, y). Then, taking a spatial mean yielded σ²ₐ (C). This process was repeated for a range of C values. The resulting σ²ₐ(C) generally agreed with the affine noise model, as in FIG. 2. From the plot of σ²ₐ(C), the parameters κ_{gray} and η were extracted. Consequently, Eq. (15) yielded χ. Thus, for example, in an experiment using N=57 light patches (sources), we obtained κ_{gray}=42.4 graylevels, η=9.0 [graylevels/light-source] thus, χ²=0.045.

Constructing Multiplexing Codes

Following the calibration, multiplexing codes were tailored. Our algorithm may deal with an arbitrary value of N or x, even if no Hadamard code or any of the matrices suggested by Wuttig exists for these parameters. In this domain, lack of competing codes in the literature has been the rule, rather than the exception. However, to make a comparison when possible, we deliberately selected, in the following experiments, special cases having values of N and x, for which competing codes exist.

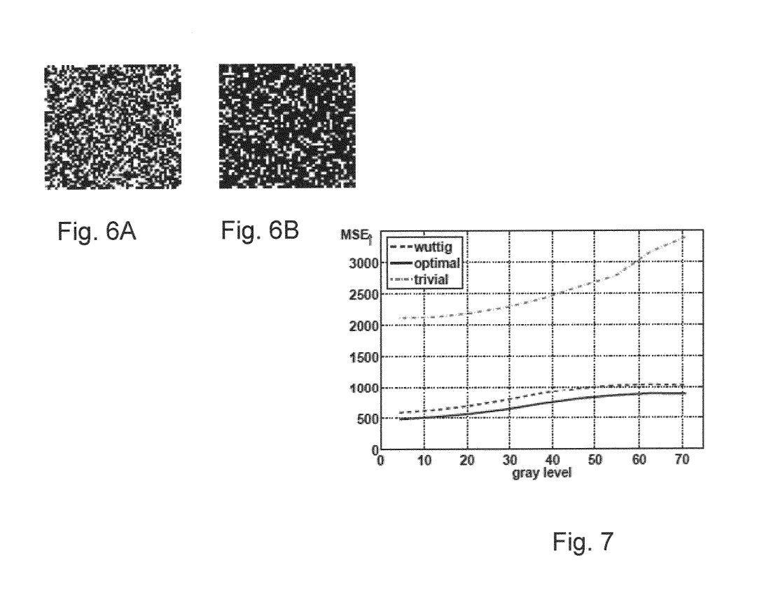

Reference is now made to FIG. 6, which illustrates multiplexing codes produced by the present embodiments during the course of the presently described experiments. FIG. 6a shows a multiplexing code for {N,C}={57, 24}. FIG. 6B shows a code for {N,C}={47, 12}. In the figures, a black pixel denote w_{m,s}=0. White denotes w_{m,s}=1. The intermediate values are in gray.

For N=57, we obtained W(Cₒₚₜ=24), shown in FIG. 6A. Wuttig yielded C=20 as the value that should be used, considering our calibrated value of x. However, Wuttig does not provide a way to obtain a multiplexing code having {N,C}={57, 20}. Rather, it only offers {N,C}={57, 8}: it is not optimal, but it is the only competing code in this specific case.

Experiments were also conducted to compare performance vs. Hadamard codes (S-matrices), for N=47 and N=11. The respective values of Cₒₚₜ in the experimental setup were Cₒₚₜ=12 and 5. The matrix corresponding to {N,C}={47, 12} is shown in FIG. 6B. In all cases, we also compared the performance to that obtained by multiplexing using the identity matrix, which may be regarded as the trivial acquisition cases.

Measurements

The present experiment made use of each set of codes to illuminate a scene while acquiring image sets. From each set of acquired images, the scene was reconstructed as if illuminated by individual illumination sources. This procedure was repeated 10 times, to facilitate empirical estimation of MSEᵢ.

For N=57, an example of a demultiplexed image is shown in FIG. 1. The corresponding MSE-ᵢ is plotted in FIG. 7, to which reference is now made. FIG. 7 shows MSEs obtained by decoding of illumination multiplexed images for N=57. The optimal code of the present embodiments outperforms both the code of Wuttig and trivial illumination.

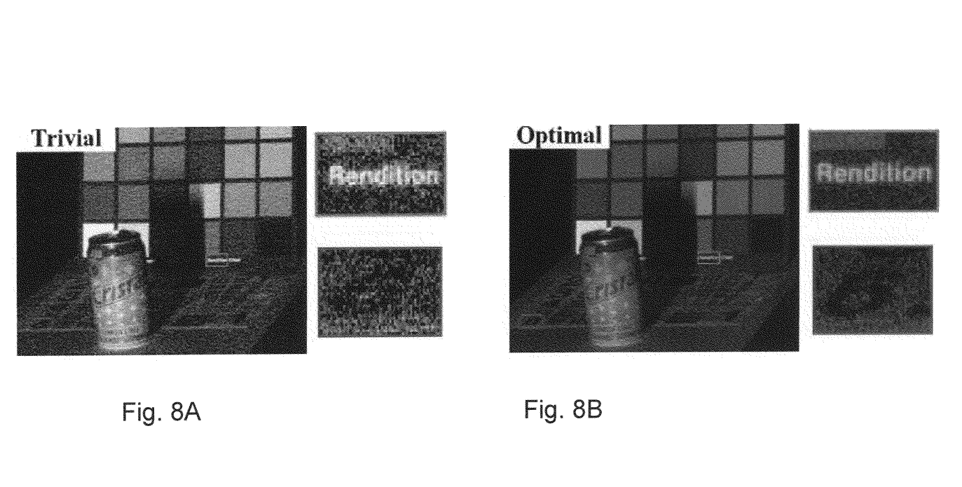

A comparative demultiplexing example for N=47 is shown in FIGS. 8A and 8B. FIG. 8A shows an image taken under a single light source. An image of the same scene, decoded from {N=47, C=12} multiplexed frames is shown in FIG. 8B. The latter is decoded as if illuminated by the same single source. The multiplexing code is optimal. The marked rectangles within the image are magnified to the right of each image.

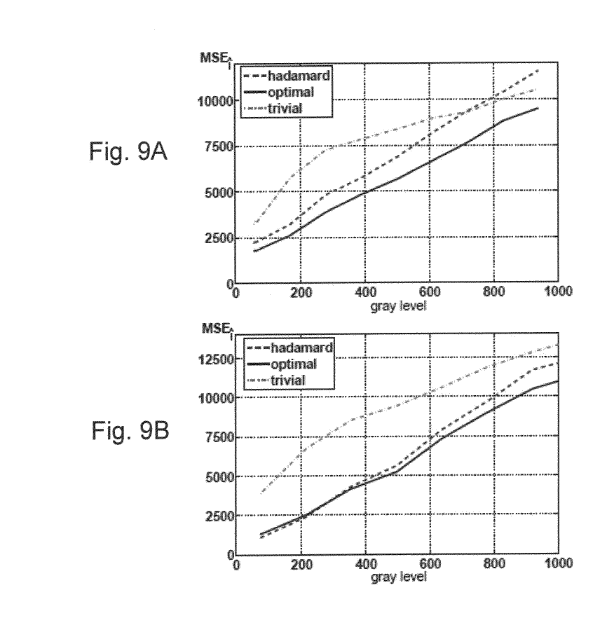

The estimated MSE-ᵢ for N=11 and N=47 are shown in FIGS. 9A and 9B respectively. MSEs of the images decoded from illumination multiplexed frames. FIG. 9A shows the case of N=11. Hadamard multiplexing becomes counter productive for high gray levels. The multiplexing code of the present embodiments is better than the Hadamard code and the identity (trivial) matrix. In FIG. 9B the Hadamard case plots only unsaturated pixels.

In these rare cases, where competing codes exist, the best multiplexing scheme (lowest output noise) is the one created by our method.

The experiment using N=47 demonstrates the implications of saturation on the applicability of Hadamard codes. In this case, single-source illumination created a bright spot in a small part of the raw image (the soda can in FIG. 8). Although most of the image is dark (graylevels up to 1000 in the 16-bit data), the highlight exhausted the dynamic range. In this case, saturation bans Hadamard code from being used. Nevertheless, we did use Hadamard codes, and the plots in FIG. 9 use only the unsaturated pixels. Needless to say, in pixels that were saturated by Hadamard-coded illumination, the data was useless. However, in these pixels saturation was avoided by the codes of the present embodiments.

General

The approach of the present embodiments provides optimal multiplexing codes for every desired number of light sources N and radiance inhibition (saturation, photon noise). It does so for cases that are much more general than those reported in the literature, covering cases for which no codes are known. By accounting for fundamental physical limits of image acquisition, we achieve results that are superior to other multiplexing codes, even when such codes exist. Our work may apply to many applications that use multiplexing, other than object lighting, for example to Xray, spectroscopy, coded aperture imaging etc. It has been shown for example that compensating for nonlinearity in y-corrected cameras induces radiance noise that is similar to the affine noise model. Hence, the formalism used here may apply to such cameras. Moreover, σₐ can also have a multiplicative component that stems from fluctuations in the light sources being multiplexed. It is thus worth accounting for this effect as well.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for multiplexing measurements of related values using predetermined numbers of sources having intensities and subject to noise, and at least one sensor subject to saturation, said multiplexing comprising measuring each of said related values under a plurality of different combinations of said sources, the method comprising:
generating a first set of multiplexing combinations;
constraining said first set with respect to said saturation;
modifying said first set with respect to said noise until a balance is found between respective intensities and noise, and
measuring said variables by multiplexing said sources according to said modified set.

2. The method of claim 1, wherein said balance comprises an optimization.

3. The method of claim 2, wherein said optimization comprises minimizing any one member of the distance functions comprising: mean square error, and weighted mean square error.

4. The method of claim 1, comprising using a noise model to model said sensor noise.

5. The method of claim 1, comprising projecting said noise model with said constraints onto a graph to form a hyperplane.

6. The method of claim 5, wherein said optimizing comprises finding a minimum within said hyperplane.

7. The method of claim 5, wherein said finding a minimum within said hyperplane comprises stepping through said hyperplane until a first minimum is reached and then iteratively perturbing said stepping to search for a bigger minimum, thereby to arrive at a global minimum.

8. The method of claim 1, wherein said sources are illumination sources.

9. The method of claim 8, wherein said illumination sources are any one of the group consisting of visible light sources, infra-red sources, ultra-violet sources, x-ray sources, pinhole sources, spatial pinholes, slots, temporal slots, varying aperture pinhole sources, coded aperture pinhole sources, single-wavelength sources, reflective sources, radar sources, and sources defined by gating intervals of a reflected signal.

10. The method of claim 1, wherein said generating said first set comprises using random values.

11. The method of claim 1, wherein intensity of respective sources is variable and wherein said generating said first set and said modifying both comprise defining source intensity values.

12. The method of claim 1, further comprising constraining said first set to any member of the group of domains consisting of the real-valued domain, the non-negative domain, and the binary domain.

13. A method for multiplexing measurements of related values using predetermined numbers of sources having intensities and subject to noise, and at least one sensor subject to saturation, said multiplexing comprising measuring each of said related values under a plurality of different combinations of said sources, the method comprising:
generating a first set of multiplexing combinations;
constraining said first set with respect to said saturation;
modifying said first set with respect to said noise until an optimum is found between respective intensities and noise, and
outputting said modified set as a measurement sequence for measuring said variables by multiplexing said sources thereby.

14. A method for multiplexing measurements of related values using predetermined numbers of wavelength sources, having respective wavelengths intensities and subject to noise, and at least one sensor subject to saturation, said multiplexing comprising measuring each of said related values under a plurality of different combinations of said sources, the method comprising:
generating a first set of multiplexing combinations;
constraining said first set with respect to said saturation;
modifying said first set with respect to said noise until an optimum is found between respective intensities and noise, and
operating a filter according to said modified set to multiplex said sources.

15. The method of claim 14, wherein said filter is a fixed filter constructed according to said set.

16. The method of claim 14, wherein said filter is a tunable filter operating comprises tuning a tunable filter according to said set.

17. The method of claim 16, wherein said tunable filter is any member of the group comprising a tunable spectrum filter, acousto-optical tunable filter, a liquid crystal tunable spectral filter.

18. The method of claim 14, wherein said operating comprises using a dispersive element with a tunable input, or a dispersive element with a tunable output.

19. A method for multiplexing measurements of related values using predetermined numbers of sources having intensities and subject to noise, and at least one sensor subject to saturation, said multiplexing comprising measuring each of said related values under a plurality of different combinations of said sources, the method comprising:
generating a first set of multiplexing combinations;
modifying said first set with respect to said noise until an optimum is found between respective intensities and noise, and
measuring said variables by multiplexing said sources according to said modified set.

20. A method for multiplexing measurements of related values using predetermined numbers of sources having intensities and subject to noise, and at least one sensor subject to saturation, said multiplexing comprising measuring each of said related values under a plurality of different combinations of said sources, the method comprising:
generating a first set of multiplexing combinations;
constraining said first set with respect to said saturation; and
measuring said variables by multiplexing said sources according to said modified set.

21. Apparatus for multiplexing measurements of related values using predetermined numbers of sources having intensities and subject to noise, and at least one sensor subject to saturation, said multiplexing comprising measuring each of said related values under a plurality of different combinations of said sources, the apparatus comprising:
a sequence generator configured to generate a first set of multiplexing combinations;
a constrainer configured for constraining said first set with respect to said saturation;
an iterative modifier configured for modifying said first set with respect to said noise until an optimum is found between respective intensities and noise, and
a measurement unit configured for measuring said variables by multiplexing said sources according to said modified set.
